(19) United States
(12) Patent Application Publication
(10) Pub. No.: US 2012/0026059 A1
(43) Pub. Date: Feb. 2, 2012

(54) ANTENNA DEVICE

(76) Inventor: Hiroki Yoshioka, Tokyo (JP)

(21) Appl. No.: 13/262,370

(22) PCT Filed: Mar. 31, 2010
(86) PCT No.: PCT/JP2010/055789

§ 371 Date: Sep. 30, 2011

(30) Foreign Application Priority Data
Apr. 3, 2009 (JP) 2009-090820

(51) Int. Cl. H01Q 1/48

(52) U.S. Cl. 343/848

(57) ABSTRACT

A circularly polarized antenna device can reduce degradation of radiation characteristics. The antenna device includes a rectangular ground plate having long sides and short sides and an antenna element disposed in the vicinity of a corner of the ground plate. The antenna element is disposed such that a longitudinal direction thereof is along an edge of the ground plate. When the long side of the ground plate has an electrical length given by L and the short side of the ground plate has an electrical length given by W, the ratio (L/W) is in the range of 1.73 to 2.75.

### TECHNICAL FIELD

This invention relates to an antenna device and, in particular, relates to an antenna device adapted to be incorporated in a portable terminal.

### BACKGROUND ART

As portable terminals, there are a mobile telephone, a portable navigation device, a notebook personal computer, a digital camera, and so on. There is a case where an antenna device is incorporated in such a portable terminal.

As such an antenna device, there is known a circularly polarized antenna device which is capable of transmitting and receiving circular polarization. A one-wavelength loop antenna, a helical antenna, a patch antenna, and so on are known as circularly polarized antenna devices. Among these circularly polarized antenna devices, the patch antenna is selected even now as a small antenna.

As is well known, the patch antenna can be miniaturized by controlling the permittivity of a dielectric which is inserted between a ground plate and a radiation electrode. However, the excessive miniaturization by the dielectric has a problem that the gain and radiation efficiency are degraded even if a material with almost no dielectric loss is used as the dielectric.

Further, a chip antenna attaching importance to its miniaturization rather than its characteristics is known as an antenna device for a portable terminal. However, normally, the chip antenna itself is an antenna capable of transmitting and receiving linear polarization, and there is no report of a chip antenna that can obtain wide-angle circular polarization characteristics capable of transmitting and receiving circular polarization.

On the other hand, JP-A-2008-11336 (Patent Document 1) discloses a chip antenna device that radiates right-handed circular polarization (RHCP). The chip antenna device disclosed in Patent Document 1 comprises an L-shaped ground plane and an omnidirectional chip antenna disposed in a cutout portion on the upper-right side of the ground plane.

### PRIOR ART DOCUMENT

### Patent Document

Patent Document 1: JP-A-2008-11336

### SUMMARY OF THE INVENTION

### Problem to be Solved by the Invention

However, the chip antenna device disclosed in Patent Document 1 has a problem that since the omnidirectional chip antenna (antenna element) should be disposed in the cutout portion of the L-shaped ground plane, the degree of freedom for the placement position of the antenna element is small. Further, according to a chip antenna device placement method disclosed in Patent Document 1, there is a possibility that the radiation characteristics are largely degraded if a clearance area becomes large or if an electronic component is disposed on the side (back side) opposite to the side where the omnidirectional chip antenna (antenna element) is mounted.

It is therefore an object of this invention to provide a circularly polarized antenna device that can reduce degradation of the radiation characteristics.

It is another object of this invention to provide a circularly polarized antenna device with a large degree of freedom for the placement position of an antenna element.

### Means for Solving the Problem

On describing the gist of an exemplary aspect of this invention, it is understood that an antenna device includes a rectangular ground plate having long sides and short sides, and an antenna element disposed in the vicinity of a corner of the ground plate. According to the exemplary aspect of this invention, the antenna element is disposed such that its longitudinal direction is along an edge of the ground plate. When the long side of the ground plate has an electrical length given by L and the short side of the ground plate has an electrical length given by W, the ratio (L/W) is in the range of 1.73 to 2.75.

### Effect of the Invention

Since an antenna element is disposed along an edge of a rectangular ground plate, an antenna device according to this invention exhibits an effect that it is possible to obtain excellent circular polarization in the front direction of the ground plate.

### BRIEF DESCRIPTION OF THE DRAWINGS

FIG. 1 is a schematic exploded perspective view showing an antenna device according to a first exemplary embodiment of this invention;

FIG. 2 is a schematic plan view of the antenna device illustrated in FIG. 1;

FIG. 3 is a schematic exploded perspective view of a specific example of the antenna device illustrated in FIGS. 1 and 2;

FIG. 4 is a schematic main part plan view of the antenna device illustrated in FIG. 3;

FIG. 5 is a diagram showing the radiation characteristics of the antenna device illustrated in FIGS. 3 and 4;

FIG. 6 is a schematic exploded perspective view showing the antenna device in the state where, in the antenna device illustrated in FIG. 3, a chip antenna is displaced by a displacement dy from a corner of a ground plate along its long side so as to be disposed;

FIG. 7 is a schematic main part plan view of the antenna device 10 illustrated in FIG. 6;

FIG. 8 is a diagram showing the axial ratio characteristics when the above-mentioned displacement dy is changed in the antenna device illustrated in FIGS. 6 and 7;

FIG. 9 is a schematic exploded perspective view showing the antenna device in the state where, in the antenna device illustrated in FIG. 3, the chip antenna is displaced by a displacement dx from the corner of the ground plate along its short side so as to be disposed;

FIG. 10 is a schematic main part plan view of the antenna device 10 illustrated in FIG. 9;

FIG. 11 is a diagram showing the axial ratio characteristics when the above-mentioned displacement dx is changed in the antenna device illustrated in FIGS. 9 and 10;

FIG. 12 is a schematic plan view showing an antenna device according to a second exemplary embodiment of this invention, wherein a chip antenna is displaced by a displacement dy from a corner of a ground plate along its long side so as to be disposed;

FIG. 13 is a diagram showing the axial ratio characteristics when the above-mentioned displacement dy is changed in the antenna device illustrated in FIG. 12;

FIG. 14 is a schematic plan view showing the antenna device according to the second exemplary embodiment of this invention, wherein the chip antenna is displaced by a displacement dx from the corner of the ground plate along its short side so as to be disposed;

FIG. 15 is a diagram showing the axial ratio characteristics when the above-mentioned displacement dx is changed in the antenna device illustrated in FIG. 14;

FIG. 16 is a schematic plan view showing an antenna device according to a third exemplary embodiment of this invention, wherein a chip antenna is displaced by a displacement dy from a corner of a ground plate along its long side so as to be disposed;

FIG. 17 is a diagram showing the axial ratio characteristics when the above-mentioned displacement dy is changed in the antenna device illustrated in FIG. 16;

FIG. 18 is a schematic plan view showing the antenna device according to the third exemplary embodiment of this invention, wherein the chip antenna is displaced by a displacement dx from the corner of the ground plate along its short side so as to be disposed;

FIG. 19 is a diagram showing the axial ratio characteristics when the above-mentioned displacement dx is changed in the antenna device illustrated in FIG. 18;

FIG. 20 is a schematic plan view showing an antenna device according to a fourth exemplary embodiment of this invention, wherein a chip antenna is displaced by a displacement dy from a corner of a ground plate along its long side so as to be disposed;

FIG. 21 is a diagram showing the axial ratio characteristics when the above-mentioned displacement dy is changed in the antenna device illustrated in FIG. 20;

FIG. 22 is a schematic plan view showing the antenna device according to the fourth exemplary embodiment of this invention, wherein the chip antenna is displaced by a displacement dx from the corner of the ground plate along its short side so as to be disposed;

FIG. 23 is a diagram showing the axial ratio characteristics when the above-mentioned displacement dx is changed in the antenna device illustrated in FIG. 22;

FIG. 24 is a schematic plan view showing a related antenna device, wherein a chip antenna is displaced by a displacement dy from a corner of a ground plate along its long side so as to be disposed;

FIG. 25 is a diagram showing the axial ratio characteristics when the above-mentioned displacement dy is changed in the antenna device illustrated in FIG. 24;

FIG. 26 is a schematic plan view showing the related antenna device, wherein the chip antenna is displaced by a displacement dx from the corner of the ground plate along its short side so as to be disposed;

FIG. 27 is a diagram showing the axial ratio characteristics when the above-mentioned displacement dx is changed in the antenna device illustrated in FIG. 26;

FIG. 28 is a schematic plan view showing an antenna device according to a fifth exemplary embodiment of this invention, wherein an L-shaped pattern antenna is displaced by a displacement dy from a corner of a ground plate along its long side so as to be disposed;

FIG. 29 is a schematic plan view showing the antenna device according to the fifth exemplary embodiment of this invention, wherein the L-shaped pattern antenna is displaced by a displacement dx from the corner of the ground plate along its short side so as to be disposed;

FIG. 30 is a schematic perspective view showing an antenna device according to a sixth exemplary embodiment of this invention, wherein an L-shaped linear antenna is displaced by a displacement dy from a corner of a ground plate along its long side so as to be disposed; and

FIG. 31 is a schematic perspective view showing the antenna device according to the sixth exemplary embodiment of this invention, wherein the

L-shaped linear antenna is displaced by a displacement dx from the corner of the ground plate along its short side so as to be disposed.

### MODE FOR CARRYING OUT THE INVENTION

Hereinbelow, exemplary embodiments of this invention will be described in detail with reference to the drawings.

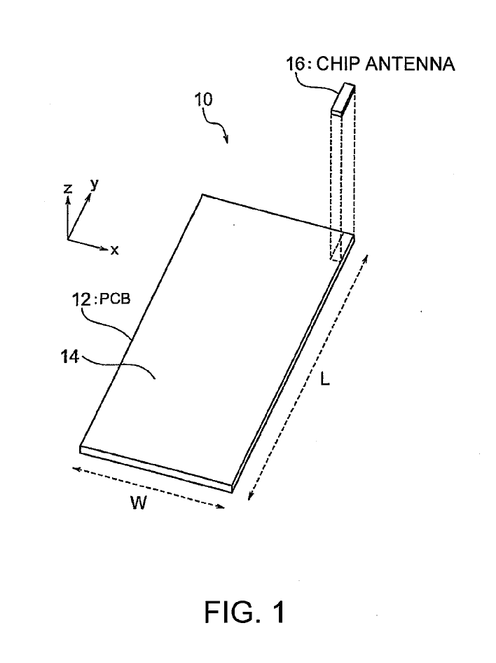

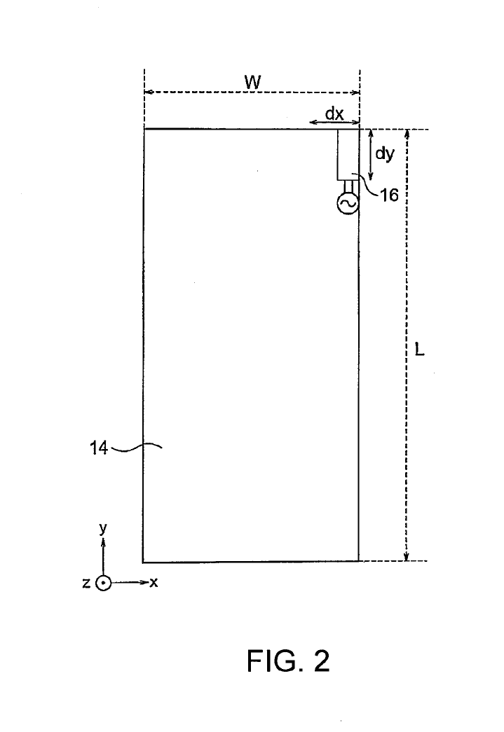

Referring to FIGS. 1 and 2, an antenna device 10 according to a first exemplary embodiment of this invention will be described. FIG. 1 is a schematic exploded perspective view showing the antenna device 10. FIG. 2 is a schematic plan view of the antenna device 10. In FIGS. 1 and 2, a left-right direction (width direction, horizontal direction) is represented by an x-axis direction, a front-rear direction (depth direction) is represented by a y-axis direction, and an up-down direction (height direction, thickness direction) is represented by a z-axis direction.

The antenna device 10 comprises a ground plate 14 and an antenna element 16. The illustrated antenna element 16 comprises a chip antenna. The ground plate 14 comprises a ground pattern formed on a main surface (upper surface) of a printed circuit board (PCB) 12. The ground plate 14 has a rectangular shape having long sides and short sides. The chip antenna 16 has a rectangular parallelepiped shape and is disposed in the vicinity of a corner of the ground plate 14. The chip antenna 16 is disposed such that its longitudinal direction is along an edge of the ground plate 14.

In the illustrated example, the long side of the ground plate 14 extends in the y-axis direction and the short side thereof extends in the x-axis direction. The electrical length of the long side of the ground plate 14 is given by L and the electrical length of the short side thereof is given by W.

In the illustrated antenna device 10, the electrical length L of the long side of the ground plate 14 is approximately equal to (½) λ (λ is the resonant wavelength of the antenna device 10), while the electrical length W of the short side of the ground plate 14 is approximately equal to (¼) λ. In other words, as will be described later, the ratio (L/W) of the electrical length L of the long side of the ground plate 14 to the electrical length W of the short side of the ground plate 14 is in the range of 1.73 to 2.75.

The resonant frequency of the chip antenna 16 itself is higher than a required specification frequency of the antenna device 10. For example, when the resonant frequency of the chip antenna 16 is 5 GHz, the required specification frequency of the antenna device 10 is 2 GHz to 2.5 GHz. The chip antenna 16 may have any configuration and may be, for example, a reverse L-shaped antenna. Power is fed to the chip antenna 16 through a non-illustrated feed line. In this event, the feed line is disposed so as not to be electrically connected to the ground plate 14. A matching circuit (not illustrated) may be connected to the chip antenna 16.

In the illustrated example, the chip antenna 16 is disposed at the corner of the ground plate 14, but, as will be described later, the chip antenna 16 may alternatively be disposed in the state where it is offset from the corner by dy in the long-side direction or by dx in the short-side direction.

In the illustrated antenna device 10, the chip antenna 16 is disposed at the right-rear corner of the ground plate 14. As a consequence, the antenna device 10 can radiate right-handed circular polarization. The placement position of the chip antenna 16 on the ground plate 14 is not limited thereto. For example, even if the chip antenna 16 is disposed at the left-front corner of the ground plate 14, the antenna device 10 can radiate right-handed circular polarization. On the other hand, in order to radiate left-handed circular polarization from the antenna device 10, the chip antenna 16 should be disposed at the left-rear corner or the right-front corner of the ground plate 14.

In the antenna device 10 thus configured, the chip antenna 16 is electromagnetically coupled to the ground plate 14 with high efficiency. Since an electromagnetic field coupled to the ground plate 14 in this event is transmitted along the perimeter of the ground plate 14 and the electrical lengths of the long and short sides of the ground plate 14 differ from each other, a phase shift occurs. As a result, excellent right-handed circular polarization is obtained in the front direction of the ground plate 14. In this event, since it is designed that radiation from the chip antenna 16 is small, degradation of the radiation efficiency of the antenna device 10 is small. Further, since a clearance area of the antenna device 10 is small, electronic components can be mounted around the antenna device 10 and on its back side. As a result, it is possible to contribute to miniaturization of a portable terminal itself.

In order to prevent degradation of the radiation efficiency of the antenna device 10, it is preferable that the chip antenna 16 be disposed on the edge of the ground plate 14 as much as possible.

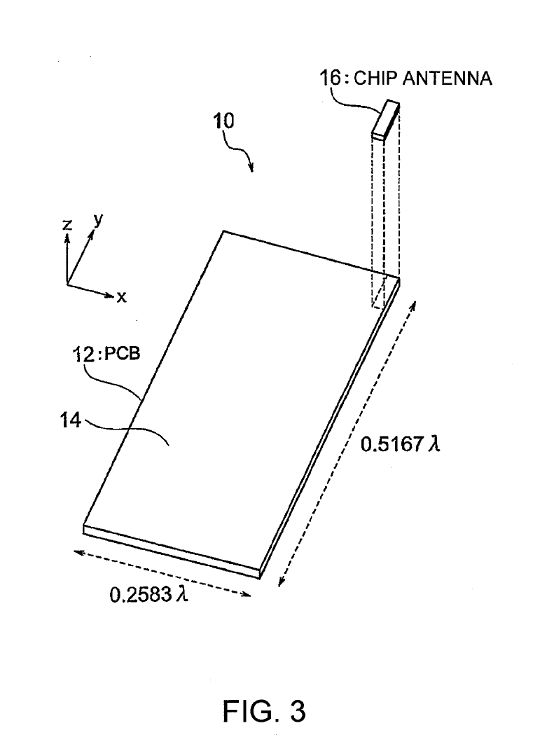

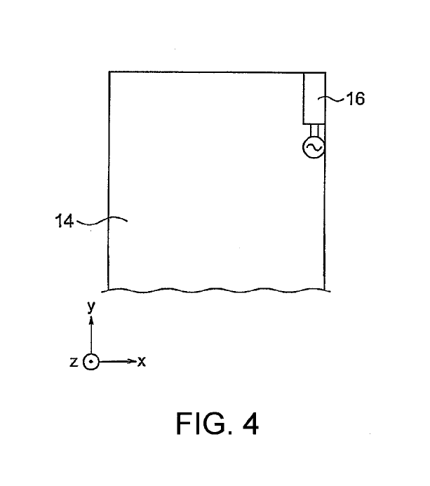

FIGS. 3 and 4 are diagrams showing a specific example (example of dimensions) of the antenna device 10 illustrated in FIGS. 1 and 2. FIG. 3 is a schematic exploded perspective view of the antenna device 10. FIG. 4 is a schematic main part plan view of the antenna device 10.

In the illustrated antenna device 10, the electrical length L of the long side of the ground plate 14 is 0.5167λ, while the electrical length W of the short side thereof is 0.2583λ. That is, the ratio (L/W) is equal to 2. Therefore, the total electrical length (L+W) of the long and short sides of the ground plate 14 is 0.7750λ. The electrical length W of the short side of the ground plate 14 is 0.28λ or less. It is to be noted that the total electrical length (L+W) of the long and short sides of the ground plate 14 should be in the range of 0.77λ to 0.78λ.

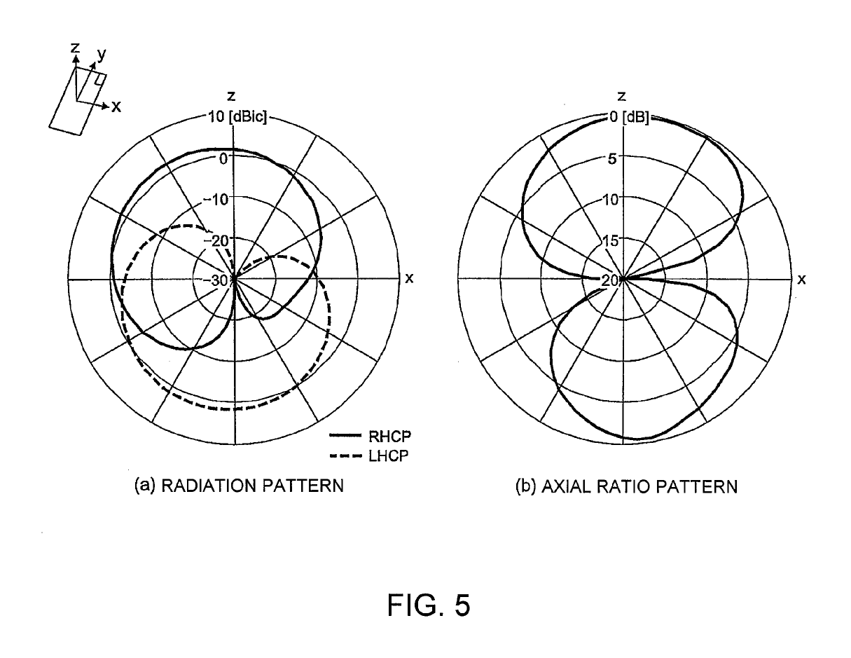

FIG. 5 shows the radiation characteristics of the antenna device 10 illustrated in FIGS. 3 and 4. In FIG. 5, (a) shows radiation patterns of the antenna device 10 and (b) shows axial ratio patterns thereof. In FIG. 5(a), RHCP represents a radiation pattern of right-handed circular polarization, while LHCP represents a radiation pattern of left-handed circular polarization.

From FIG. 5(a), it is seen that the right-handed circular polarization is radiated from the upper surface of the antenna device 10. From FIG. 5(b), it is seen that the axial ratio characteristics of the antenna device 10 in the upward direction are good.

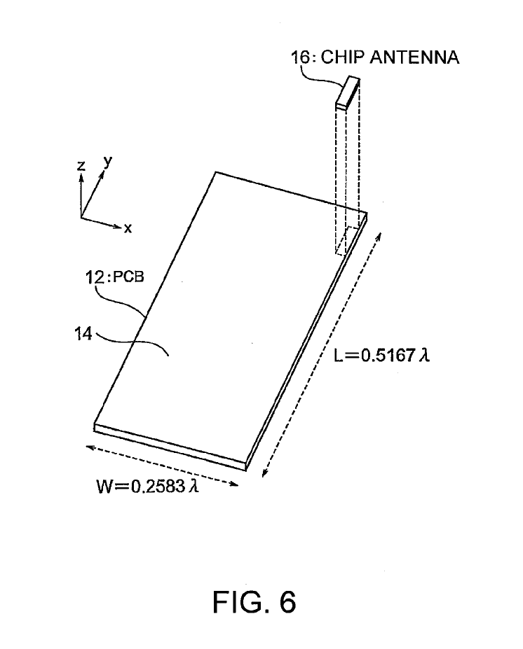

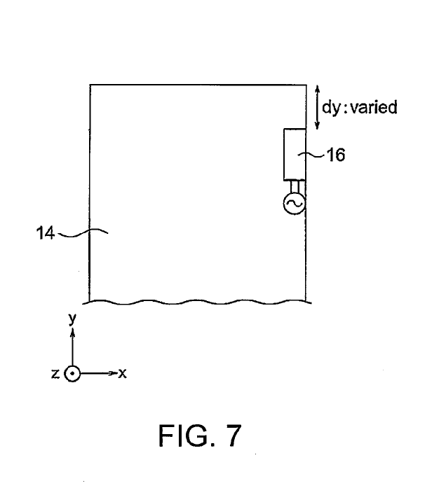

FIGS. 6 and 7 show the antenna device 10 in the state where the chip antenna 16 is displaced by dy from the corner of the ground plate 14 along its long side so as to be disposed. FIG. 6 is a schematic exploded perspective view of the antenna device 10, while FIG. 7 is a schematic main part plan view of the antenna device 10 illustrated in FIG. 6.

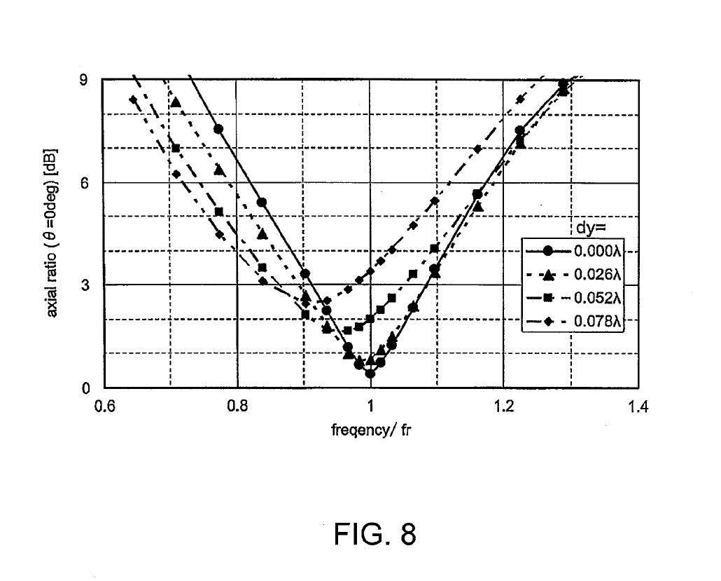

FIG. 8 is a diagram showing the axial ratio characteristics when the above-mentioned displacement dy is changed in the antenna device 10 illustrated in FIGS. 6 and 7. In FIG. 8, the abscissa axis represents the frequency (frequency/fr) normalized by the resonant frequency fr and the ordinate axis represents the axial ratio [dB] when the angle θ is 0 degrees. It is reported that the axial ratio should be 3dB or less as the characteristics of an antenna device.

From FIG. 8, it is seen that the axial ratio characteristics of the antenna device 10 are best when dy=0.000λ, i.e. when the chip antenna 16 is disposed at the corner. Further, it is seen that as the displacement dy increases, the axial ratio characteristics are shifted to the low frequency side. It is seen that even when dy=0.078λ, there is a range where the axial ratio is 3 dB or less. That is, the displacement dy can be in the range of about 0.1509 L or less.

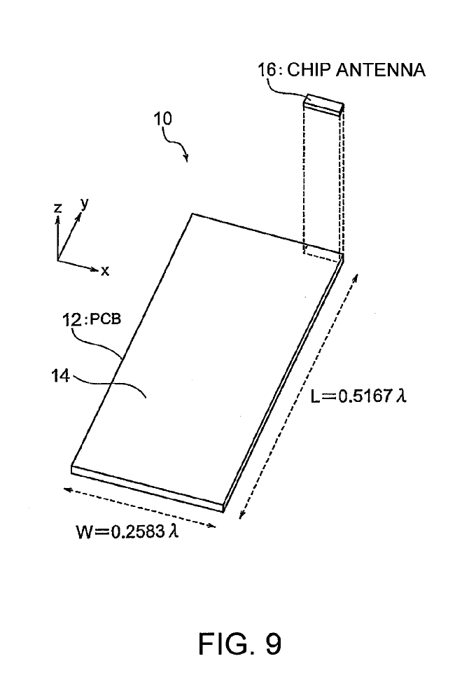

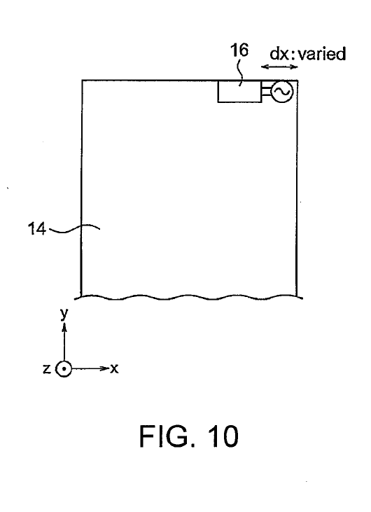

FIGS. 9 and 10 show the antenna device 10 in the state where the chip antenna 16 is displaced by dx from the corner of the ground plate 14 along its short side so as to be disposed. FIG. 9 is a schematic exploded perspective view of the antenna device 10, while FIG. 10 is a schematic main part plan view of the antenna device 10 illustrated in FIG. 9.

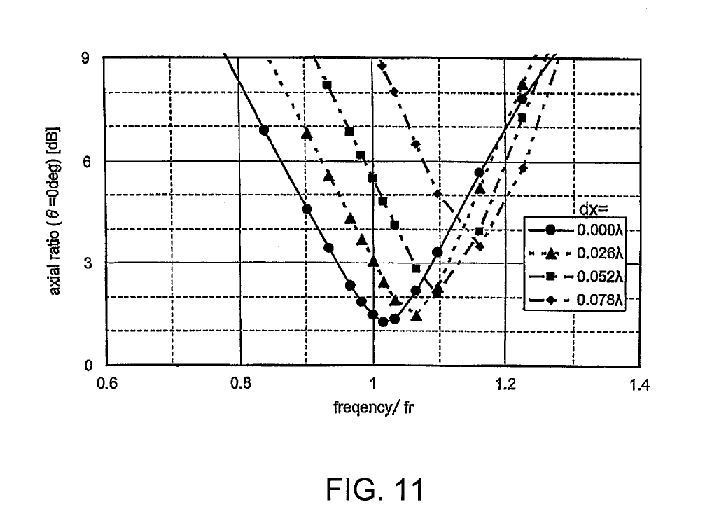

FIG. 11 is a diagram showing the axial ratio characteristics when the above-mentioned displacement dx is changed in the antenna device 10 illustrated in FIGS. 9 and 10. In FIG. 11, the abscissa axis represents the frequency (frequency/fr) normalized by the resonant frequency fr and the ordinate axis represents the axial ratio [dB] when the angle θ is 0 degrees.

From FIG. 11, it is seen that the axial ratio characteristics of the antenna device 10 are best when dx=0.000λ, i.e. when the chip antenna 16 is disposed at the corner. Further, it is seen that as the displacement dx increases, the axial ratio characteristics are shifted to the high frequency side. It is seen that even when dx=0.052λ, there is a range where the axial ratio is 3 dB or less. That is, the displacement dx can be in the range of about 0.2236 W or less.

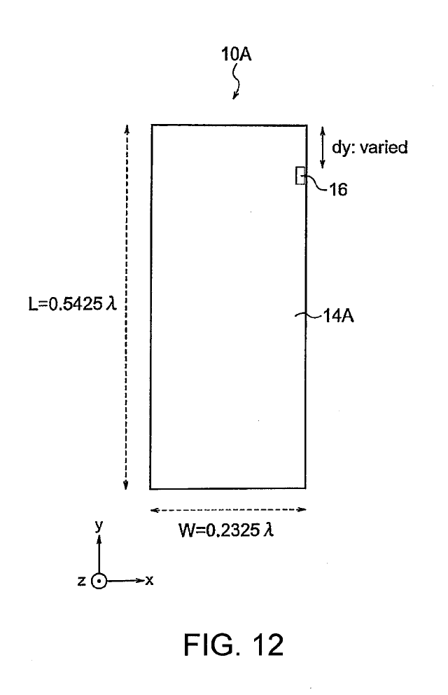

Referring to FIGS. 12 to 15, an antenna device 10A according to a second exemplary embodiment of this invention will be described. The illustrated antenna device 10A has the same structure as the antenna device 10 illustrated in FIGS. 3 and 4 except that the dimensions of a ground plate differ from those shown in FIGS. 3 and 4. Accordingly, the ground plate is assigned reference symbol 14A.

In the illustrated antenna device 10A, the electrical length L of a long side of the ground plate 14A is 0.5425λ, while the electrical length W of a short side thereof is 0.2325λ. That is, the ratio (L/W) is equal to about 2.333. Therefore, the total electrical length (L+W) of the long and short sides of the ground plate 14 is 0.7750λ.

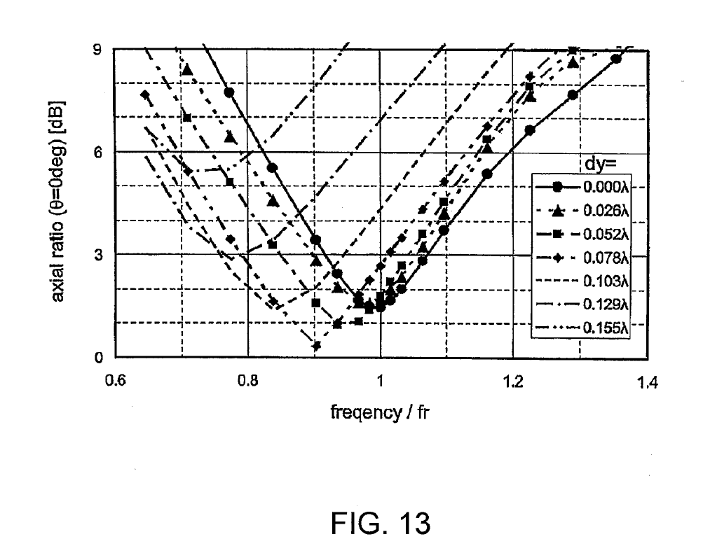

FIG. 12 is a schematic plan view showing the antenna device 10A, wherein a chip antenna 16 is displaced by a displacement dy from a corner of the ground plate 14A along its long side so as to be disposed. FIG. 13 is a diagram showing the axial ratio characteristics when the above-mentioned displacement dy is changed. In FIG. 13, the abscissa axis represents the frequency (frequency/fr) normalized by the resonant frequency fr and the ordinate axis represents the axial ratio [dB] when the angle θ is 0 degrees.

From FIG. 13, it is seen that as the displacement dy increases, the axial ratio characteristics are shifted to the low frequency side and further are improved. It is seen that even when dy=0.129λ, there is a range where the axial ratio is 3 dB or less. That is, the displacement dy can be in the range of about 0.2378 L or less.

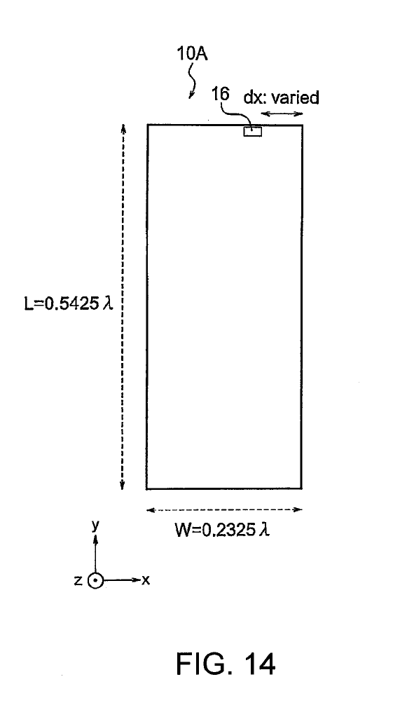

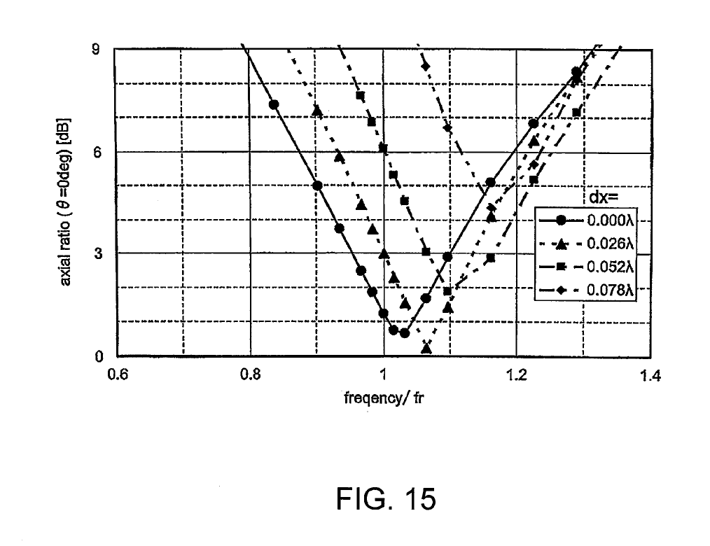

FIG. 14 is a schematic plan view showing the antenna device 10A, wherein the chip antenna 16 is displaced by a displacement dx from the corner of the ground plate 14A along its short side so as to be disposed. FIG. 15 is a diagram showing the axial ratio characteristics when the above-mentioned displacement dx is changed. In FIG. 15, the abscissa axis represents the frequency (frequency/fr) normalized by the resonant frequency fr and the ordinate axis represents the axial ratio [dB] when the angle is 0 degrees.

From FIG. 15, it is seen that the axial ratio characteristics are best when the displacement dx=0.026λ. Further, it is seen that as the displacement dx increases, the axial ratio characteristics are shifted to the high frequency side. It is seen that even when dx=0.052λ, there is a range where the axial ratio is 3 dB or less. That is, the displacement dx can be in the range of about 0.2237 W or less.

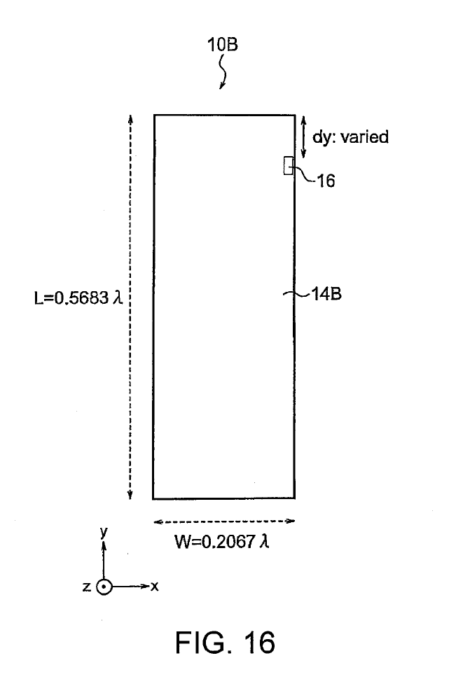

Referring to FIGS. 16 to 19, an antenna device 10B according to a third exemplary embodiment of this invention will be described. The illustrated antenna device 10B has the same structure as the antenna device 10 illustrated in FIGS. 3 and 4 except that the dimensions of a ground plate differ from those shown in FIGS. 3 and 4. Accordingly, the ground plate is assigned reference symbol 14B.

In the illustrated antenna device 10B, the electrical length L of a long side of the ground plate 14B is 0.5683λ, while the electrical length W of a short side thereof is 0.2067λ. That is, the ratio (L/W) is equal to about 2.75. Therefore, the total electrical length (L+W) of the long and short sides of the ground plate 14B is 0.7750λ.

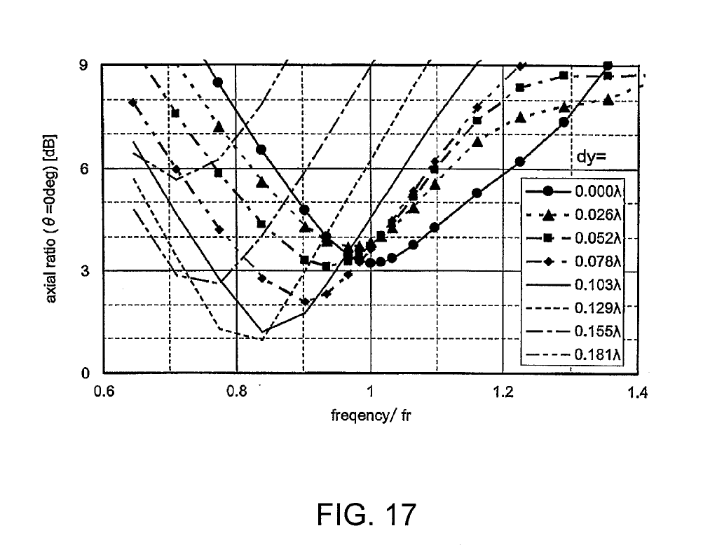

FIG. 16 is a schematic plan view showing the antenna device 10B, wherein a chip antenna 16 is displaced by a displacement dy from a corner of the ground plate 14B along its long side so as to be disposed. FIG. 17 is a diagram showing the axial ratio characteristics when the above-mentioned displacement dy is changed. In FIG. 17, the abscissa axis represents the frequency (frequency/fr) normalized by the resonant frequency fr and the ordinate axis represents the axial ratio [dB] when the angle θ is 0 degrees.

From FIG. 17, it is seen that, in the range where the displacement dy is 0.078λ to 0.155λ, there are ranges where the axial ratio is 3 dB or less. Further, it is seen that as the displacement dy increases, the axial ratio characteristics are shifted to the low frequency side. That is, the displacement dy can be in the range of about 0.2727 L or less.

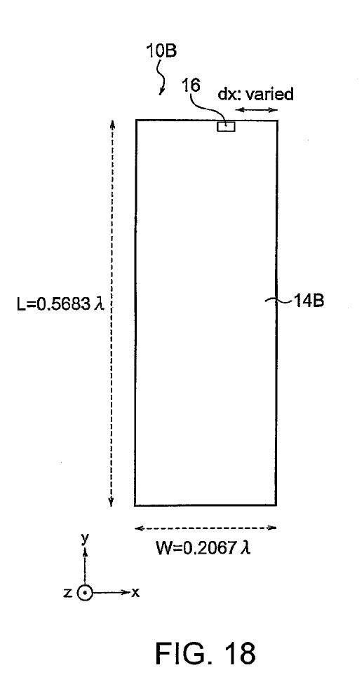

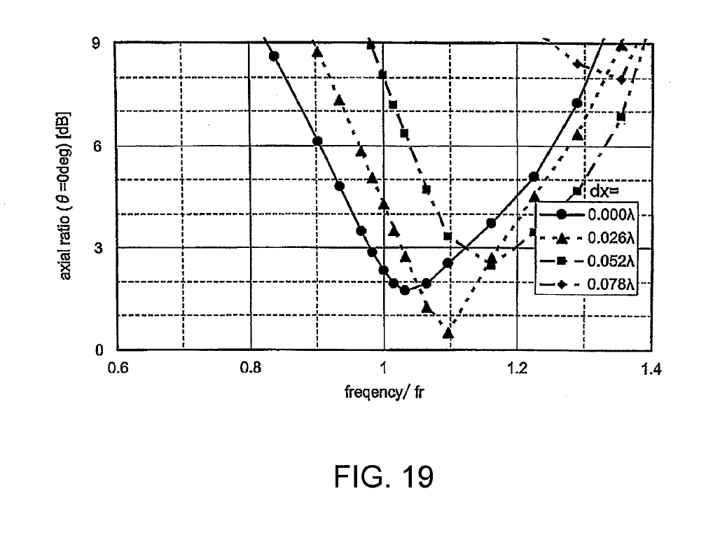

FIG. 18 is a schematic plan view showing the antenna device 10B, wherein the chip antenna 16 is displaced by a displacement dx from the corner of the ground plate 14B along its short side so as to be disposed. FIG. 19 is a diagram showing the axial ratio characteristics when the above-mentioned displacement dx is changed. In FIG. 19, the abscissa axis represents the frequency (frequency/fr) normalized by the resonant frequency fr and the ordinate axis represents the axial ratio [dB] when the angle θ is 0 degrees.

From FIG. 19, it is seen that the axial ratio characteristics are best when the displacement dx=0.026λ. Further, it is seen that as the displacement dx increases, the axial ratio characteristics are shifted to the high frequency side. It is seen that even when dx=0.052λ, there is a range where the axial ratio is 3 dB or less. That is, the displacement dx can be in the range of about 0.2515 W or less.

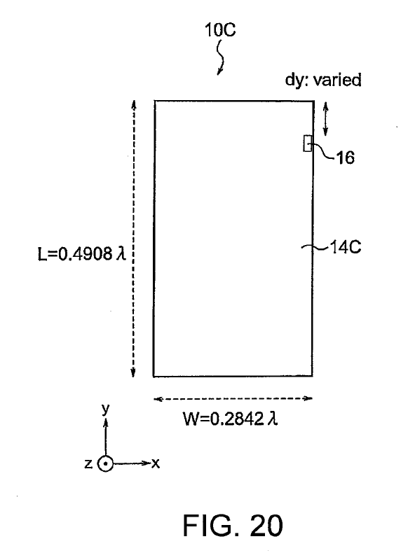

Referring to FIGS. 20 to 23, an antenna device 10C according to a fourth exemplary embodiment of this invention will be described. The illustrated antenna device 10C has the same structure as the antenna device 10 illustrated in FIGS. 3 and 4 except that the dimensions of a ground plate differ from those shown in FIGS. 3 and 4. Accordingly, the ground plate is assigned reference symbol 14C.

In the illustrated antenna device 10C, the electrical length L of a long side of the ground plate 14C is 0.4908λ, while the electrical length W of a short side thereof is 0.2842λ. That is, the ratio (L/W) is equal to about 1.73. Therefore, the total electrical length (L+W) of the long and short sides of the ground plate 14C is 0.7750λ.

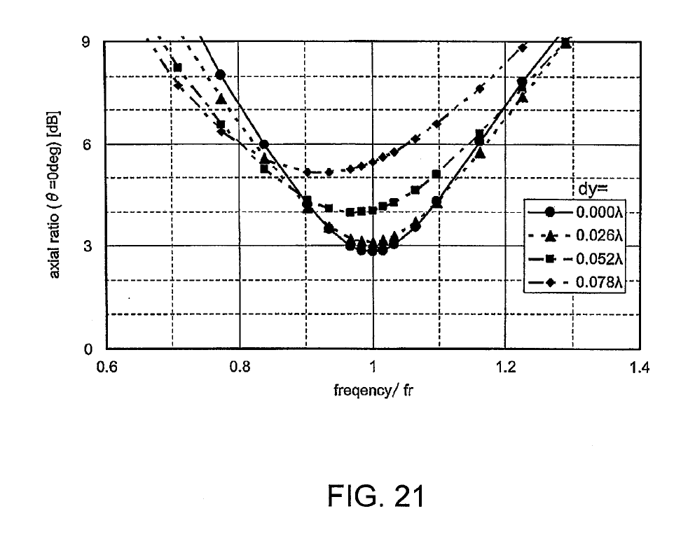

FIG. 20 is a schematic plan view showing the antenna device 10C, wherein a chip antenna 16 is displaced by a displacement dy from a corner of the ground plate 14C along its long side so as to be disposed. FIG. 21 is a diagram showing the axial ratio characteristics when the above-mentioned displacement dy is changed. In FIG. 21, the abscissa axis represents the frequency (frequency/fr) normalized by the resonant frequency fr and the ordinate axis represents the axial ratio [dB] when the angle θ is 0 degrees.

From FIG. 21, it is seen that when the displacement dy is 0.000λ, i.e. when the chip antenna 16 is disposed at the corner of the ground plate 14C, there is a range where the axial ratio is 3 dB or less. However, it is seen that when the displacement dy exists, the axial ratio becomes 3 dB or more.

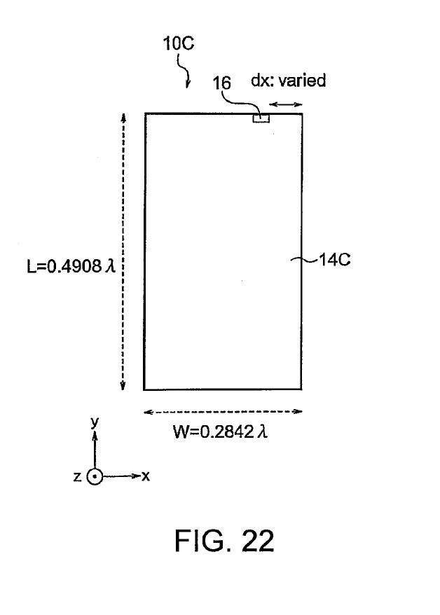

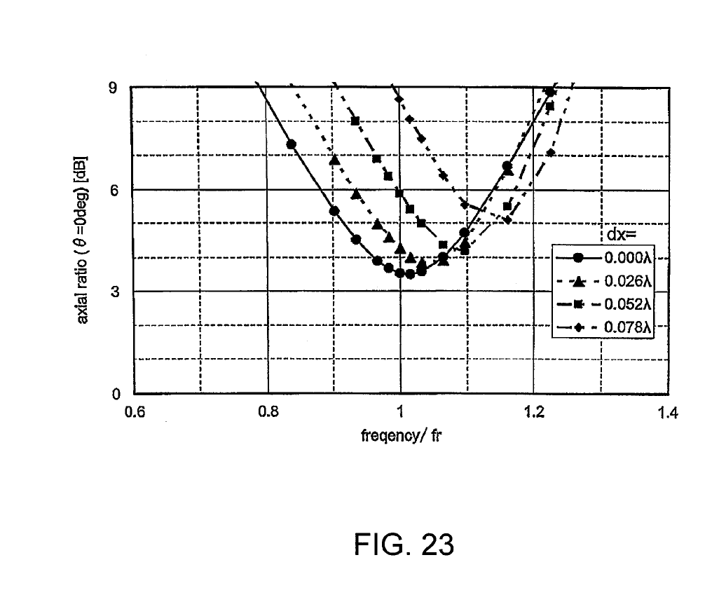

FIG. 22 is a schematic plan view showing the antenna device 10C, wherein the chip antenna 16 is displaced by a displacement dx from the corner of the ground plate 14C along its short side so as to be disposed. FIG. 23 is a diagram showing the axial ratio characteristics when the above-mentioned displacement dx is changed. In FIG. 23, the abscissa axis represents the frequency (frequency/fr) normalized by the resonant frequency fr and the ordinate axis represents the axial ratio [dB] when the angle θ is 0 degrees.

From FIG. 23, it is seen that the axial ratio characteristics are best when the displacement dx=0.000λ, while the axial ratio is 3 dB or more. Further, it is seen that as the displacement dx increases, the axial ratio characteristics are shifted to the high frequency side.

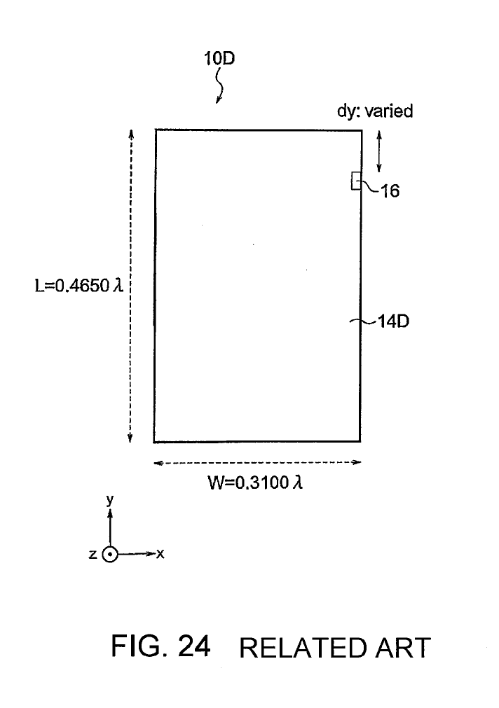

Referring to FIGS. 24 to 27, a related antenna device 10D will be described. The illustrated antenna device 10D has the same structure as the antenna device 10 illustrated in FIGS. 3 and 4 except that the dimensions of a ground plate differ from those shown in FIGS. 3 and 4. Accordingly, the ground plate is assigned reference symbol 14D.

In the related antenna device 10D, the electrical length L of a long side of the ground plate 14D is 0.465λ, while the electrical length W of a short side thereof is 0.3100λ. That is, the ratio (L/W) is equal to 1.5. Therefore, the total electrical length (L+W) of the long and short sides of the ground plate 14D is 0.775λ.

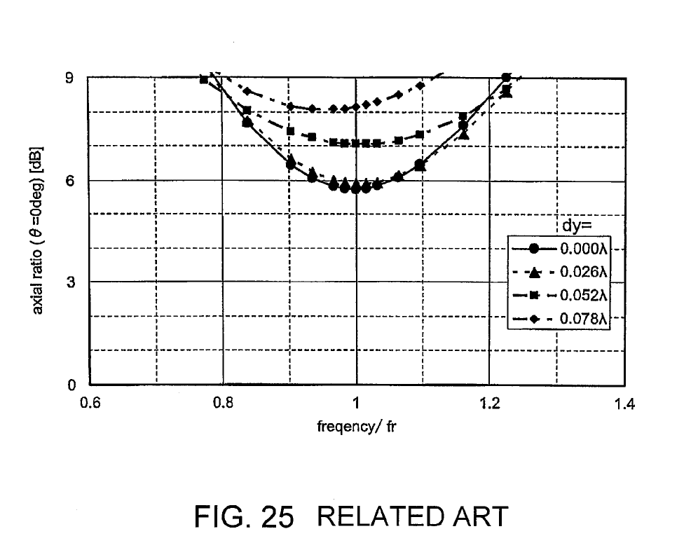

FIG. 24 is a schematic plan view showing the antenna device 10D, wherein a chip antenna 16 is displaced by a displacement dy from a corner of the ground plate 14D along its long side so as to be disposed. FIG. 25 is a diagram showing the axial ratio characteristics when the above-mentioned displacement dy is changed. In FIG. 25, the abscissa axis represents the frequency (frequency/fr) normalized by the resonant frequency fr and the ordinate axis represents the axial ratio [dB] when the angle θ is 0 degrees.

From FIG. 25, it is seen that the axial ratio is 3 dB or more with any of the displacements dy.

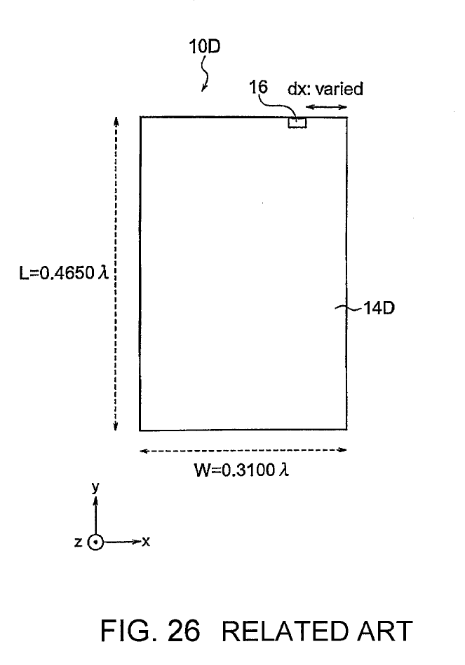

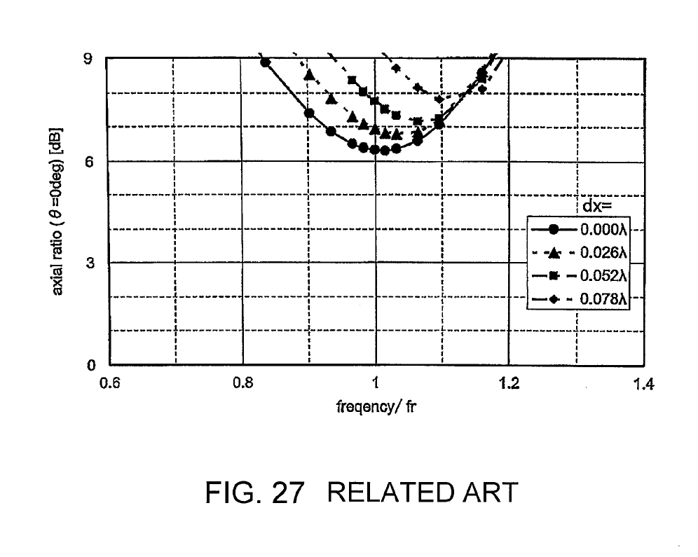

FIG. 26 is a schematic plan view showing the antenna device 10D, wherein the chip antenna 16 is displaced by a displacement dx from the corner of the ground plate 14D along its short side so as to be disposed. FIG. 27 is a diagram showing the axial ratio characteristics when the above-mentioned displacement dx is changed. In FIG. 27, the abscissa axis represents the frequency (frequency/fr) normalized by the resonant frequency fr and the ordinate axis represents the axial ratio [dB] when the angle θ is 0 degrees.

From FIG. 27, it is seen that the axial ratio is 3 dB or more with any of the displacements dx.

From the above, it is seen that the ratio (L/W) of the electrical length L of the long side of the ground plate to the electrical length W of the short side of the ground plate should be in the range of 1.73 to 2.75. Further, it is seen that the chip antenna 16 should be disposed with the displacement dy in the range of 0.2727 L or less from the corner of the ground plate along its long side. Alternatively, it is seen that the chip antenna 16 should be disposed with the displacement dx in the range of 0.2515 W or less from the corner of the ground plate along its short side.

Further, it is seen that the frequency at which circular polarization is obtained can be adjusted by shifting the placement position of the chip antenna 16 on the edge of the ground plate.

In the above-mentioned embodiments, the description has been made by giving, as an example, the antenna device in which the rectangular parallelepiped chip antenna 16 is employed as the antenna element, but the antenna element is not limited thereto.

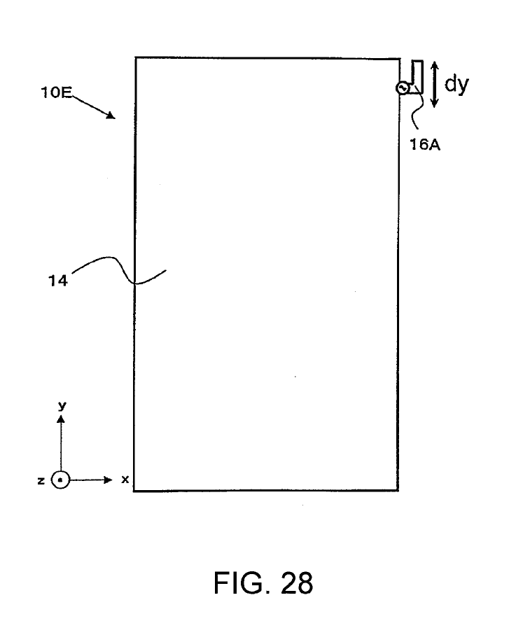

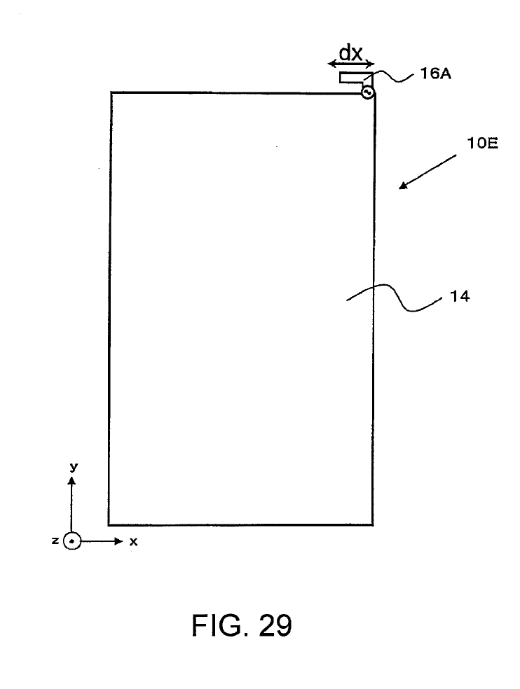

Referring to FIGS. 28 and 29, an antenna device 10E according to a fifth exemplary embodiment of this invention will be described. The illustrated antenna device 10E has the same structure as the antenna device 10 illustrated in FIGS. 3 and 4 except that an L-shaped pattern antenna is used as an antenna element. Accordingly, the antenna element (L-shaped pattern antenna) is assigned reference symbol 16A.

FIG. 28 is a schematic plan view showing the antenna device 10E, wherein the L-shaped pattern antenna 16A is displaced by a displacement dy from a corner of a ground plate 14 along its long side so as to be disposed. FIG. 29 is a schematic plan view showing the antenna device 10E, wherein the L-shaped pattern antenna 16A is displaced by a displacement dx from the corner of the ground plate 14 along its short side so as to be disposed.

The present inventor has confirmed that, even with the antenna device 10E illustrated in FIGS. 28 and 29, it is possible to obtain excellent circular polarization in the front direction of the ground plate 14.

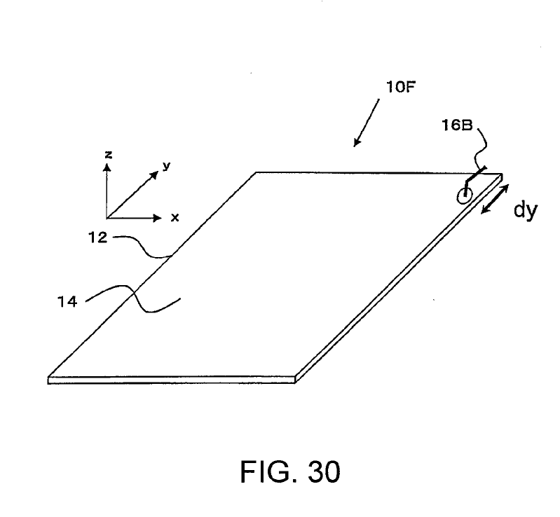

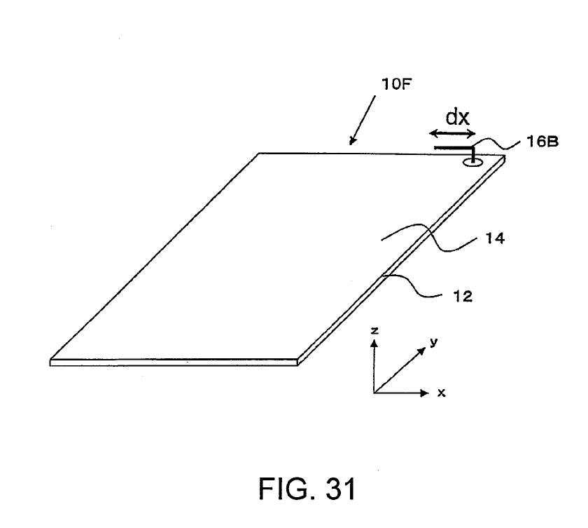

Referring to FIGS. 30 and 31, an antenna device 1 OF according to a sixth exemplary embodiment of this invention will be described. The illustrated antenna device 1 OF has the same structure as the antenna device 10 illustrated in FIGS. 3 and 4 except that an L-shaped linear antenna is used as an antenna element. Accordingly, the antenna element (L-shaped linear antenna) is assigned reference symbol 16B.

FIG. 30 is a schematic perspective view showing the antenna device 10F, wherein the L-shaped linear antenna 16B is displaced by a displacement dy from a corner of a ground plate 14 along its long side so as to be disposed. FIG. 31 is a schematic perspective view showing the antenna device 10F, wherein the L-shaped linear antenna 16B is displaced by a displacement dx from the corner of the ground plate 14 along its short side so as to be disposed.

The present inventor has confirmed that, even with the antenna device 10F illustrated in FIGS. 30 and 31, it is possible to obtain excellent circular polarization in the front direction of the ground plate 14.

In the above-mentioned antenna devices according to the exemplary aspects of this invention, the antenna element may be in the form of the rectangular parallelepiped chip antenna, may be in the form of the L-shaped pattern antenna, or may be in the form of the L-shaped linear antenna. The resonant frequency of the antenna element itself may be higher than the required specification frequency of the antenna device. The antenna element can be disposed with a displacement in the range of 0.2727 L or less from the corner of the ground plate along its long side. Alternatively, the antenna element can be disposed with a displacement in the range of 0.2515 L or less from the corner of the ground plate along its short side. It is more preferable that the ratio (L/W) be equal to 2.

While this invention has been particularly shown and described with reference to the exemplary embodiments thereof, this invention is not limited to these embodiments. It will be understood by those of ordinary skill in the art that various changes in form and details may be made therein without departing from the spirit and scope of the present invention as defined by the claims. For example, the shape of the ground plate is not necessarily rectangular. The reason is that the electrical size (length) of the ground plate determines the frequency at which circular polarization occurs. For example, the corners, where the antenna element is not mounted, of the ground plate may be rounded. In the above-mentioned exemplary embodiments, the antenna element is disposed with its longitudinal direction being inside the ground plate and along the edge of the ground plate, but this invention is not limited thereto. For example, the antenna element may be disposed with its longitudinal direction being outside the ground plate and along the edge of the ground plate. That is, it is sufficient that the antenna element is disposed such that its longitudinal direction is along the edge of the ground plate. In other words, it is sufficient that the antenna element is disposed in the vicinity of the edge of the ground plate.

This application is based upon and claims the benefit of priority from Japanese Patent Application No. 2009-90820, filed on Apr. 3, 2009, the disclosure of which is incorporated herein in its entirety by reference.

### DESCRIPTION OF SYMBOLS

10, 10A, 10B, 100, 10E, 1OF antenna device

12 printed circuit board (PCB)

14, 14A, 14B, 14C ground plate

16 chip antenna (antenna element)

16A L-shaped pattern antenna (antenna element)

16B L-shaped linear antenna (antenna element)

L electrical length of a long side of a ground plate

W electrical length of a short side of a ground plate

dx, dy displacement

1. An antenna device comprising:
a rectangular ground plate having a long side and a short side; and
an antenna element disposed in the vicinity of a corner of the ground plate;
wherein the antenna element is disposed such that a longitudinal direction thereof is along an edge of the ground plate; and
wherein when the long side of the ground plate has an electrical length given by L and the short side of the ground plate (14; 14A; 14B; 140) has an electrical length given by W, a ratio (L/W) is in a range of 1.73 to 2.75.

2. The antenna device according to claim 1, wherein the antenna element comprises a rectangular parallelepiped chip antenna.

3. The antenna device according to claim 1, wherein the antenna element comprises an L-shaped pattern antenna.

4. The antenna device according to claim 1, wherein the antenna element comprises an L-shaped linear antenna.

5. The antenna device according to claim 1, wherein the antenna element itself has a resonant frequency higher than a required specification frequency of the antenna device.

6. The antenna device according to claim 1, wherein the antenna element is disposed with a displacement in a range of 0.2727 L or less from the corner of the ground plate along the long side thereof.

7. The antenna device according to claim 1, wherein the antenna element is disposed with a displacement in range of 0.2515 W or less from the corner of the ground plate along the short side thereof.

8. The antenna device according to claim 1, wherein the ratio (L/W) is equal to 2.
